(19) United States
(12) Patent Application Publication
(10) Pub. No.: US 2017/0176956 A1
(43) Pub. Date: Jun. 22, 2017

(54) CONTROL SYSTEM USING INPUT-AWARE STACKER

(71) Applicant: Microsoft Technology Licensing, LLC, Redmond, WA (US)

(72) Inventors: Nicolo Fusi, Boston, MA (US); Jennifer Listgarten, Cambridge, MA (US); Miriam Huntley, Cambridge, MA (US)

(21) Appl. No.: 14/972,729

(22) Filed: Dec. 17, 2015

(51) Int. Cl. G05B 13/02

(52) U.S. Cl. CPC G05B 13/026; G05B 13/0265

(57) ABSTRACT

A control system comprises an input configured to receive sensor data sensed from a target system to be controlled by the control system. The control system has an input-aware stacker, the input-aware stacker being a predictor; and a plurality of base predictors configured to compute base outputs from features of the sensor data. The input-aware stacker is input-aware in that it is configured to take as input the features as well as the base outputs to compute a prediction. The input-aware stacker is configured to compute the prediction from uncertainty data about the base outputs and/or from at least some combinations of the features of the sensor data. The control system has an output configured to send instructions to the target system on the basis of the computed prediction.

### BACKGROUND

As big data increasingly becomes available, through the internet of things, web-based data stores, live data streams from diverse sources, historical data sets and more, there is an increasing challenge to use the data to accurately control systems in practical time scales. Even though huge volumes of data may be available, the task of using it to control systems such as manufacturing systems, robotic systems, medical equipment, domestic heating systems and many others is not trivial.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A control system comprises an input configured to receive sensor data sensed from a target system to be controlled by the control system. The control system has an input-aware stacker, the input-aware stacker being a predictor; and a plurality of base predictors configured to compute base outputs from features of the sensor data. That is, the input-aware stacker is input-aware in that it is configured to take as input the features as well as the base outputs to compute a prediction. The input-aware stacker is configured to compute the prediction from uncertainty data about the base outputs and/or from at least some combinations of the features of the sensor data. The control system has an output configured to send instructions to the target system on the basis of the computed prediction.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a control system;

FIG. 2 is a schematic diagram of the machine learning system of FIG. 1;

FIG. 3 is a schematic diagram of training data and a process for creating base training data, sensor features and evaluation data;

FIG. 4 is a schematic diagram of a training system for training a plurality of base predictors;

FIG. 5 is a schematic diagram of a training system for training an input-aware stacker;

FIG. 6 is a schematic diagram of a feature combiner;

FIG. 7 is a flow diagram of a method of training an input-aware stacker and a method of operating a trained input-aware stacker;

FIG. 8 illustrates an exemplary computing-based device in which embodiments of a control system and an input-aware stacker may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

An efficient control system is described which makes use of potentially very large amounts of data sensed from a target system. The control system has a new type of input-aware stacking system which is a trained machine learning system that takes input from a plurality of base predictors and also from features of sensed data. The new type of input-aware stacker is able to compute accurate predictions so that the control system is efficient.

An input-aware stacker is described which is a type of predictor, comprised of a plurality of base predictors and a stacker configured to compute outputs not only from the base predictor outputs, but also from sensor data—the so-called inputs in an input-aware stacker. The joint process of training and using the base predictors with the input-aware stacker may be an input-aware stacking system. That is, the input aware stacker is input aware in that it is configured to take as input the features as well as the base outputs to compute a prediction. The input aware stacker is configured to compute the prediction not only from the point predictions of the base predictors, but also from their uncertainty in their respective base outputs and/or from at least some combinations of the features of the sensor data.

In some examples the input-aware stacker has improved accuracy because it uses data about uncertainty of outputs of the base predictors. For example, where the base predictors are probabilistic the base predictors compute predictions and also uncertainty information about the computed predictions. For example, where the base predictors are not probabilistic, a distribution over base predictions may be generated and fitted to obtain uncertainty information. In some examples the uncertainty data is input as stand-alone features to the input-aware stacker. In some examples the uncertainty data is combined with other inputs to the input-aware stacker.

In some examples the input-aware stacker has improved accuracy because it uses particular combinations of the sensor data features and/or base predictor outputs. Various different combinations may be evaluated empirically for a given application domain and a particular combination selected. At least some of the combinations may be non-linear. Combinations of sensor data features may be obtained by reducing the dimensionality of the sensor data features. In some examples this is done jointly as part of the input-aware stacker process. In some examples this is done to compute features which are input to the stacker.

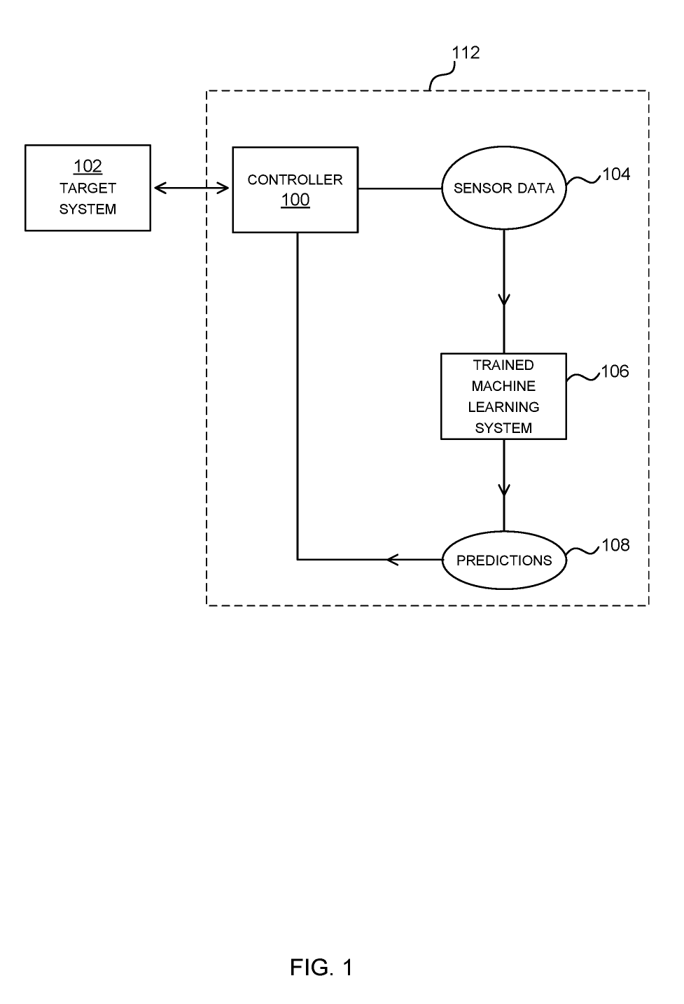

FIG. 1 is a schematic diagram of a control system 112 for controlling target system 102. A non-exhaustive list of examples of the target system is email spam filter, telecommunications bandwidth management system, medical equipment, automotive vehicle, robotic system, computer security system and others. A controller 100 has an interface to the target system 102 and is able to send instructions to control the target system 102 on the basis of predictions 108 computed by the control system 112. The controller detects or accesses sensor data 104 sensed from the target system 102 such as email data, telecommunications equipment status data, telecommunications bandwidth data, medical equipment sensor data, vehicle sensor data, robotic sensor data, computer security event data and others. The sensor data is input to a trained machine learning system 106 which computes predictions about the behavior of the target system 102. The trained machine learning system 106 comprises an input-aware stacker.

The functionality of the control system 112 can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

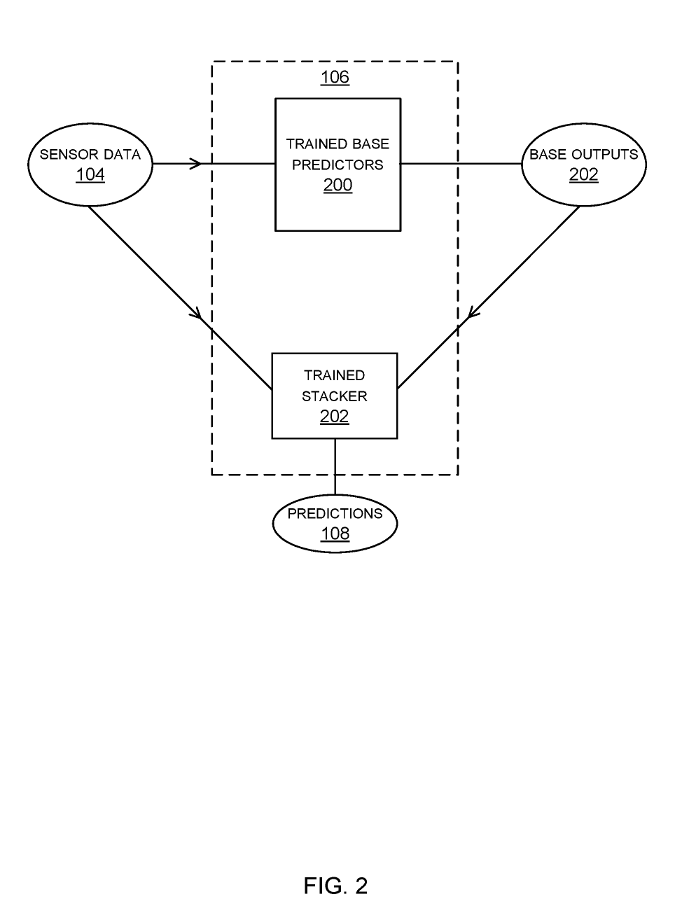

FIG. 2 is a schematic diagram of the machine learning system 106 of FIG. 1 in a test mode, where the machine learning system is being used to compute predictions for new incoming sensor data 104. The machine learning system 106 comprises a plurality of trained base predictors 200 and a trained stacker 202. A trained base predictor is any classifier or regressor and a non-exhaustive list of examples is: neural network, support vector machine, random decision forest, directed acyclic graph, Bayesian model, or others. The base predictors can be probabilistic or non-probabilistic and there can be a mixture of probabilistic and non-probabilistic base predictors. Features of the sensor data 104 are input to the trained base predictors to compute predictions referred to herein as base outputs 202.

The trained stacker 202 is any classifier or regressor. As for the base predictors, the trained stacker 202 can be probabilistic or non-probabilistic. The trained stacker is configured to combine the base predictors 202 using stacked generalization in which no constraints are placed on the base models, and the base models can be combined in any way. The trained stacker 202 is input-aware because it takes input from the sensor data 104 as well as from the base outputs 202.

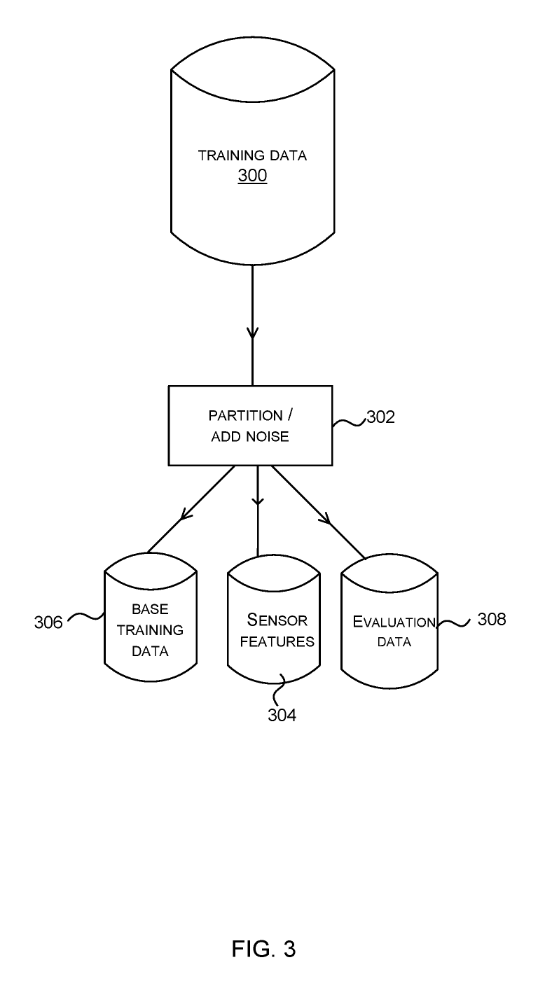

FIG. 3 is a schematic diagram of training data 300 and a process for creating base training data 306, sensor features 304 and evaluation data 308. The training data 300 comprises labeled examples of the sensor data 104. For example, email data labelled as being spam or not spam. For example, features of telecommunications network and equipment data labeled with quality of service class labels. In some examples first noise is added to the training data 300 to create the base training data, second noise is added to the training data 300 to create the sensor features 304 and third noise is added to the training data 300 to create the evaluation data 308. The first, second and third noise has different characteristics from each other and this enables overfitting to be avoided. Overfitting is where a machine learning system is unable to generalize to examples which are dissimilar to those on which it was trained. By adding noise in this way the amounts of the base, stack and evaluation data are the same as the amount of training data 300. In contrast, methods which partition the training data 300 produce smaller amounts of base, stack or evaluation data than training data 300.

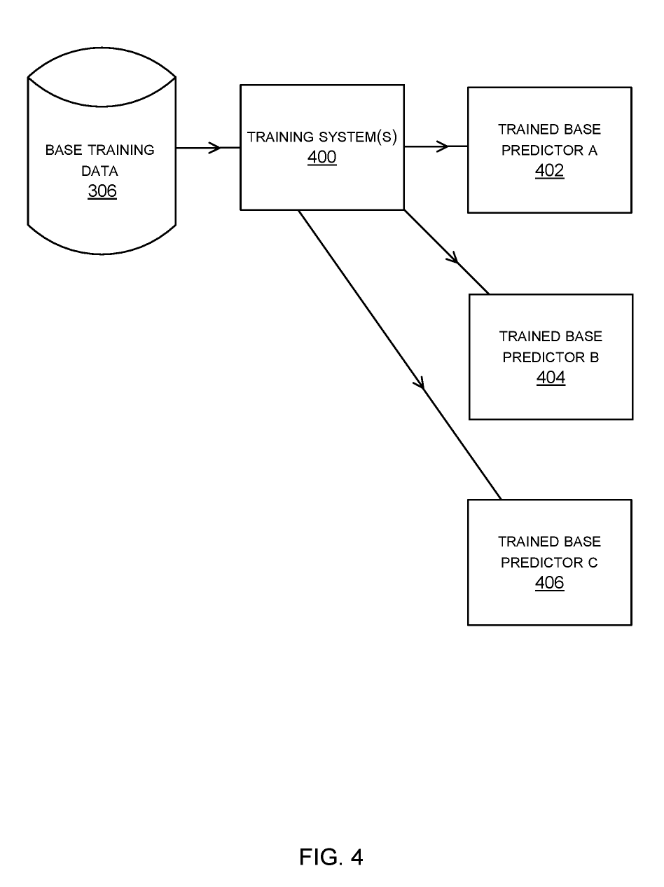

FIG. 4 is a schematic diagram of a plurality of base predictors 402, 404, 406 and a training system 400 for training the base predictors. Base training data 306 is used to train the base predictors 402, 404, 406. The base predictors may be trained independently of one another using different training objectives.

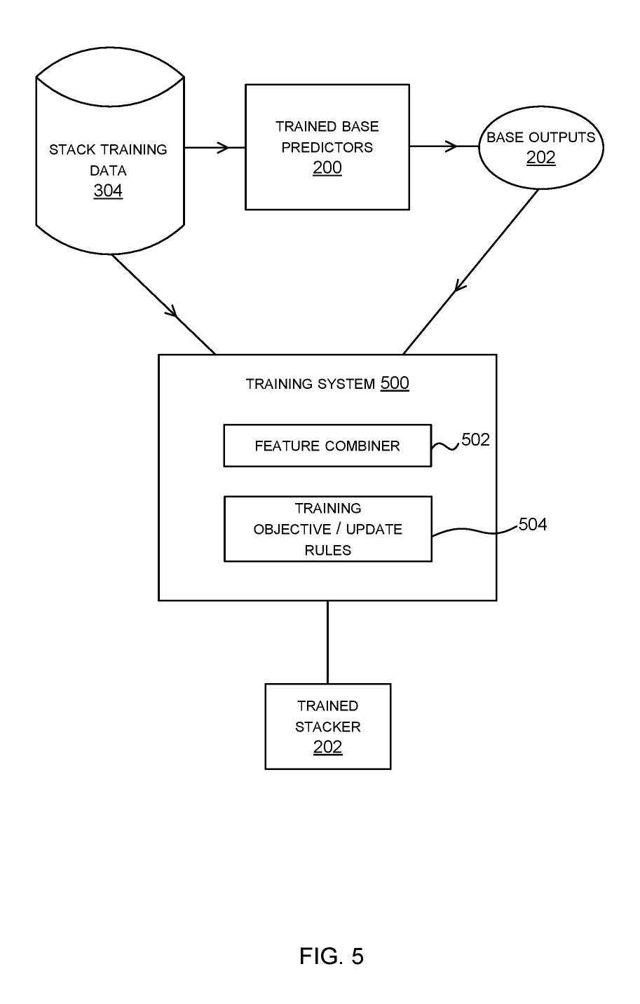

FIG. 5 is a schematic diagram of a training system 500 for training an input-aware stacker 202. The training system 500 takes as input base outputs 202 from the trained base predictors 200 and sensor features 304. The training system has a feature combiner 502 and one or more training objectives or update rules 504. The training system updates values of parameters of the stacker in the light of the training data according to the training objective or update rules to be used.

In some examples the feature combiner uses uncertainty data about the base outputs 202. In some examples the feature combiner reduces the dimensionality of the sensor features. In some examples the feature combiner combines features of the sensor features and/or base outputs 202 using at least some non-linearity.

In an example, the training system 500, 400 accesses training data 300 (see FIG. 3) and computes a first set of training data (the base training data 306) from the accessed training data. The training system 400 trains each of the base predictors using the first set of training data (see FIG. 4). The training system 500 computes a second set of training data (which is used to train the input-aware stacker) from the accessed training data 300 and from outputs 202 of the base predictors, where the first set of training data and the second set of training data are partially or completely overlapping apart from the addition of independent sets of noise as described below. The training system 500 trains the input-aware stacker using the second set of training data; wherein the first set of training data and the second set of training data both use the same accessed training data 300. For example, the first set of training data and the second set of training data both use all of the accessed training data 300. This gives the benefit of improved accuracy of the resulting trained input-aware stacker because the amount of training data 300 available is fully used for the training process rather than being partitioned.

For example, the training system 400 is configured to compute the first set of training data by adding a first set of noise to the accessed training data 300; and to compute the second set of training data by adding a second set of noise to features derived from the first set of training data, and by adding the second noise to features derived from the outputs of the base predictors, where the first and second sets of noise are independent of one another.

In some examples the training system 500 includes an evaluation facility to evaluate the performance of the input-aware tracker for a plurality of different ways of combining the features. Evaluation data as described with reference to FIG. 3 is used for this purpose. The evaluation facility is able to evaluate the performance of the control system for a plurality of different types of base predictor. The control system has access, in some examples, to a library of classifiers and regressors for use in the base predictors and the stacker. It has access to a library of different embedding functions for use in the reducer. By using the evaluation facility it is possible to select which combinations of types of base predictors, stacker and feature combinations are optimal for a particular application domain.

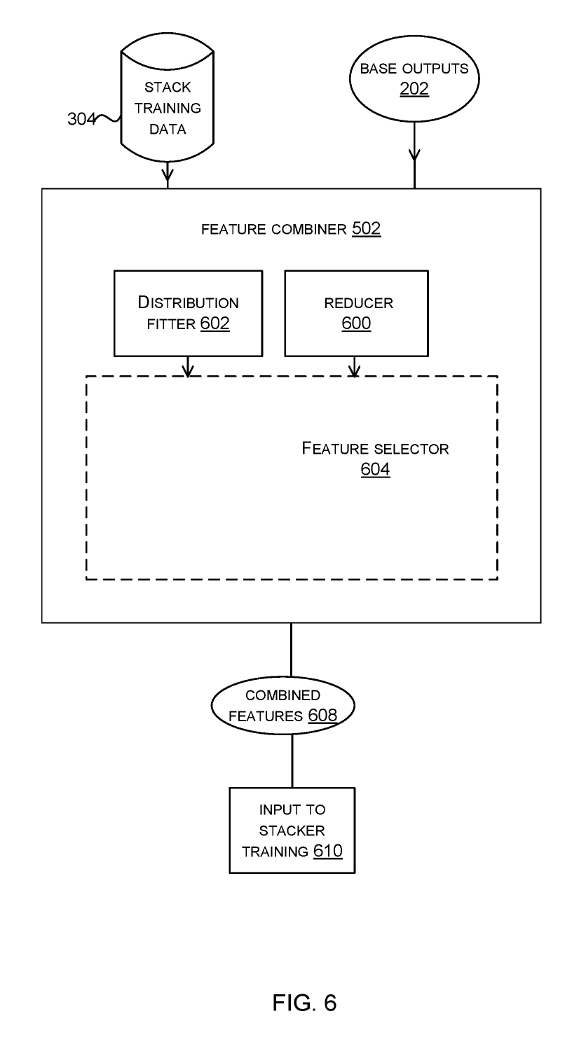

The feature combiner 502 is now described in more detail with reference to FIG. 6.

FIG. 6 shows the feature combiner which takes inputs comprising sensor features 304 and base outputs 202. The feature combiner acts to combine features of the sensor features 304 and/or the base outputs 202 to generate combined features 608 which are input to the stacker 610. Various different ways of combining the features are possible.

In some examples the feature combiner 502 acts to incorporate uncertainty from the base predictors into the stacker. This can be achieved in a variety of ways. Incorporating uncertainty from the base predictors gives improved accuracy since the stacker becomes input-aware with respect to the uncertainty in the space of the base model predictions. As a result different base predictors can be combined using a stacker on the basis of how well they predict and also by their level of uncertainty in different regions of the space (the space of possible examples of sensor data).

Where a base predictor is probabilistic, in that it computes uncertainty data associated with each prediction it computes, then the feature combiner 502 receives this uncertainty data as part of the base outputs 202. For example, in the case of a random decision forest as a base predictor, the base output may be a score that an image element depicts a particular body part and an indication of how uncertain the prediction is (e.g. a score of 0.9 that the body part is an arm). In some examples, where the base predictors are probabilistic, the stacker is implemented using, for example, Gaussian Process regression or classification. With such probabilistic base models, the probability data in the base outputs 202 is usable in a fully probabilistic and principled way, including use of the uncertainty revealed by the probabilistic distributions. Furthermore, if the stacking model itself is probabilistic, then the stacker has a built-in mechanism for propagating the uncertainty from the base outputs 202 which can then be used. Also, using a probabilistic model for the stacker, such as Gaussian Process, enables handling a hybrid-uncertain approach wherein the base model outputs have uncertainty while the sensor features do not.

In the case that a base predictor is not probabilistic, the base predictor can be arranged to generate a distribution of outputs, from which their probabilistic distribution, or features (e.g. mean and variance) is estimated. In this case, the feature combiner 502 may comprise a distribution fitter 602 which fits probability distributions to a plurality of base outputs 202 from each base predictor. The distribution fitter may approximate the full distribution over the outputs of the base predictor by some finite number of moments (e.g. mean and standard variation). The distribution fitter 602 can use bootstrap or derivative-based methods to fit the distribution or any other method of fitting a distribution to base model outputs which are not inherently probabilistic. Statistics describing the probability distribution fitted by the distribution fitter such as mean and standard variation can be used as features 608 to input to the stacker. In some examples the statistics are input as auxiliary features to the stacker, either alone or as interactions with the base outputs 202. For example, base outputs 202 associated with a higher probability according to the fitted distribution may be given higher importance when input to the stacker.

In some examples the feature combiner 502 combines sensor features 304 and/or base outputs 202 in ways which take into account distinctions between these two types of input. It is recognized herein that sensor features can be higher-dimensional that the dimensionality of the output vector from all of the base models (which is a vector of base predictions, one from each of the base predictors obtained for the same input sensor data item). Therefore performance of the stacker can be improved if the feature combiner has a reducer 600 to reduce dimensionality of the sensor features. The reducer 600 can be for example, a linear or non-linear process for embedding the sensor features into a lower-dimensional space, jointly as part of the input-aware stacking process. Such a joint embedding can be implemented using a Gaussian Process or a Deep Gaussian Process or in other ways.

In another example, the reducer 600 comprises an embedding/dimensionality reduction algorithm. A non-exhaustive list of examples is: principal components analysis (PCA), stochastic neighbor embedding (SNE), t distributed stochastic neighbor embedding (t-SNE), locally linear embedding (LLE), local tangent space alignment (LTSA), topological data analysis (TDA). The results from one or more such dimensionality reduction algorithm may be input as features in the input-aware stacker.

In some examples, the feature combiner 502 comprises a feature selector 604 which, in addition to, or as an alternative to the operation of the reducer 600, carries out feature selection on the sensor features. In this way some of the sensor features are omitted from input to the stacker, for example, if they are features which do not help with prediction. Other constraints can be applied by the feature combiner 502 so that the sensor features 304 and the base outputs 202 are treated differently. For example, by making linear combinations of sensor features features and non-linear combinations of base outputs 202, by making non-linear combinations of sensor features and linear combinations of base outputs 202, or by making linear combinations of both sensor features and base outputs 202.

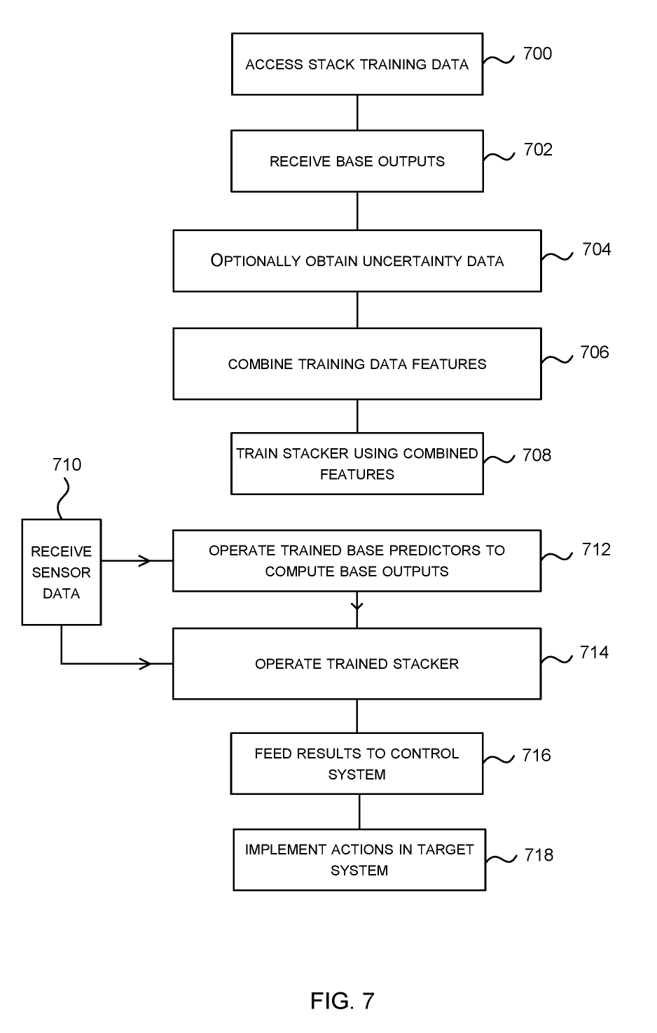

FIG. 7 is a flow diagram of a method of training an input-aware stacker and a method of operating a trained input-aware stacker. The method of training is carried out by the training system 500 and comprises accessing sensor features 700, receiving base outputs 702, and optionally obtaining uncertainty data 704. For example, the uncertainty data is obtained using the distribution fitter 602 or as part of the base outputs 202. The training system 500 combines the training data features 706 and trains the stacker using the combined features 708. The different ways of combining the training data features are described with reference to FIG. 6 and include using reducer 600 or using distribution fitter 602, or using feature selector 604 or any combination of one or more of these.

Once the stacker has been trained it is possible to use the trained stacker to compute predictions from sensor data not previously seen by the stacker. The stacker receives sensor data 710 and operates the trained base predictors to compute base outputs 712. The trained stacker receives 714 the base outputs and the sensor data 710 and operates to compute predictions. The prediction results are fed 716 to the control system which implements actions 718 in the target system.

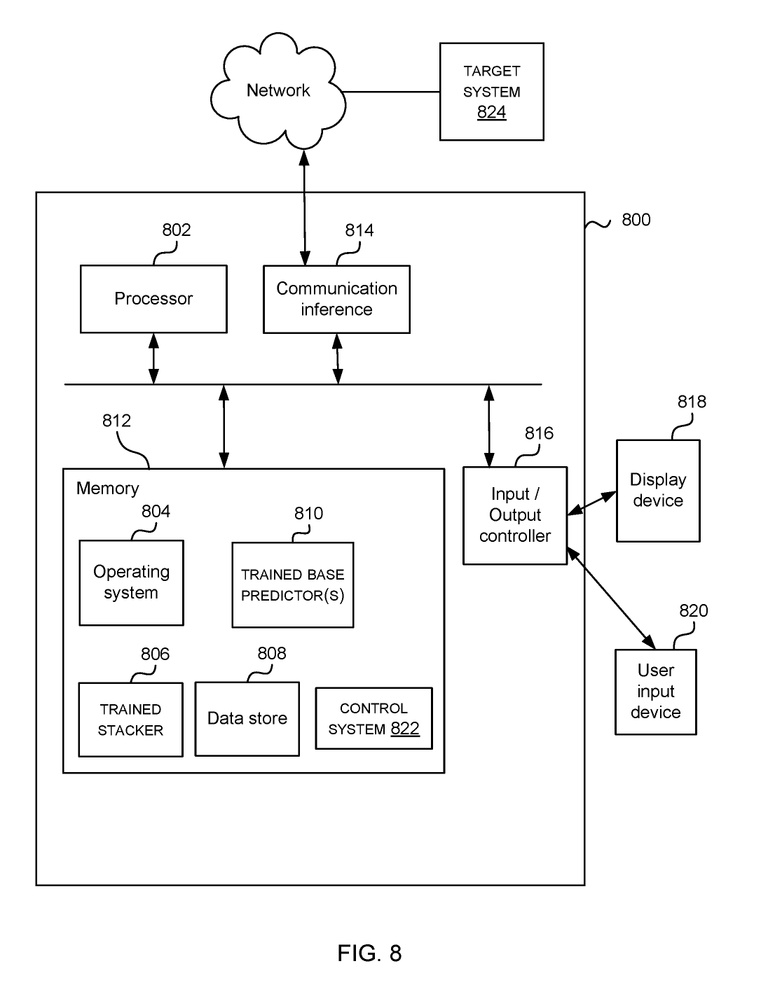

FIG. 8 illustrates various components of an exemplary computing-based device 800 which may be implemented as any form of a computing and/or electronic device, and in which embodiments of a control system using an input-aware stacker such as trained stacker 806 may be implemented. The control system is configured to control one or more target systems 824 connected to the computing-based device via a network as illustrated in FIG. 8 or integral with the computing-based device. In some examples, a training system for training the trained stacker 806 is implemented using the computing-based device 800. A training system for training one or more base predictors may also be present at the computing-based device.

Computing-based device 800 comprises one or more processors 802 which may be microprocessors, controllers or any other suitable type of processors for processing computer executable instructions to control the operation of the device in order to control a target system 824 using one or more trained base predictors 810 and a trained stacker 806. The computing executable instructions may also control the operation of the device to carry out training of the trained stacker 806 and/or base predictors 810. In some examples, for example where a system on a chip architecture is used, the processors 802 may include one or more fixed function blocks (also referred to as accelerators) which implement a part of the method of controlling the target system 824 in hardware (rather than software or firmware). Platform software comprising an operating system 804 or any other suitable platform software may be provided at the computing-based device to enable application software to be executed on the device. The application software may comprise one or more trained base predictors 810 and a trained stacker 806. The computer executable instructions also implement a control system 822.

The computer executable instructions may be provided using any computer-readable media that is accessible by computing based device 800. Computer-readable media may include, for example, computer storage media such as memory 800 and communications media. Computer storage media, such as memory 800, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 812) is shown within the computing-based device 800 it will be appreciated that the storage may be distributed or located remotely and accessed via a network or other communication link (e.g. using communication interface 814).

The computing-based device 800 also comprises an input/output controller 816 arranged to output display information to a display device 818 which may be separate from or integral to the computing-based device 800. The display information may provide a graphical user interface. The input/output controller 816 is also arranged to receive and process input from one or more devices, such as a user input device 820 (e.g. a mouse, keyboard, camera, microphone or other sensor). In some examples the user input device 820 may detect voice input, user gestures or other user actions and may provide a natural user interface (NUI). This user input may be used to select a type of machine learning system to be used by the base predictors and/or trained stacker, to specify sources of training data, to specify sources of sensor data, to view predictions computed by the trained stacker, to view base outputs, or for other reasons. In an embodiment the display device 818 may also act as the user input device 820 if it is a touch sensitive display device. The input/output controller 816 may also output data to devices other than the display device.

Any of the input/output controller 816, display device 818 and the user input device 820 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Alternatively or in addition to the other examples described herein, examples include any combination of the following:

A control system comprising:

an input configured to receive sensor data sensed from a target system to be controlled by the control system;

an input-aware stacker, the input-aware stacker being a predictor;

a plurality of base predictors configured to compute base outputs from features of the sensor data;

the input-aware stacker being input-aware in that it is configured to take as input the features as well as the base outputs to compute a prediction; and wherein the input-aware stacker is configured to compute the prediction from uncertainty data about the base outputs and/or from at least some combinations of the features of the sensor data; and

an output configured to send instructions to the target system on the basis of the computed prediction.

For example, the input-aware stacker is a Gaussian process stacker which is a predictor which represents each of its inputs with a normally distributed random variable.

In an example the control system comprises a distribution fitter configured to fit, for at least one of the base predictors, a distribution to the base outputs from the at least one base predictor, and wherein the input-aware stacker is configured to take statistics of the distribution as inputs.

For example, the input-aware stacker is configured to take as inputs, interactions between the statistics and the base outputs.

In an example the control system comprises a feature combiner configured to compute at least some, but not all, combinations of the features non-linearly.

For example the feature combiner is configured to compute the combinations of the features, the feature combiner comprising a reducer configured to reduce the dimensionality of the sensor data features.

For example the reducer is configured to reduce the dimensionality of the sensor data features, jointly as part of a process at the input-aware stacker.

For example the reducer is configured to reduce the dimensionality of the sensor data features and to input the reduced dimensionality sensor data features as input to the input-aware stacker.

For example the reducer is configured to compute two or more dimensionality reductions of the sensor data features and to input the reduced dimensionality sensor data features as input to the input-aware stacker.

For example the feature combiner is configured to treat the sensor data features and the base outputs differently.

For example, the control system comprises a training system configured to:

access training data;

compute a first set of training data from the accessed training data and train each of the base predictors using the first set of training data;

compute a second set of training data from the accessed training data and from outputs of the base predictors where the first set of training data and the second set of training data are partially or completely overlapping, where the second set of training data is different from the first set of training data; and

train the input-aware stacker using the second set of training data; wherein the first set of training data and the second set of training data both use the same accessed training data.

For example, the training system is configured to compute the first set of training data by adding first noise to the accessed training data; and

to compute the second set of training data by adding second noise to features derived from the first set of training data, and by adding the second noise to features derived from the outputs of the base predictors, where the first and second sets of noise are independent of one another.

In an example there is a computer-implemented method comprising:

receiving sensor data sensed from a target system to be controlled by the control system;

computing base outputs from features of the sensor data using a plurality of base predictors;

inputting at least some of the features and the base outputs to an input-aware stacker to compute a prediction; the input-aware stacker computing the prediction with uncertainty data from the base predictors and/or with at least some combinations of the features of the sensor data; and

sending instructions to the target system to control the target system on the basis of the computed prediction.

For example the method uses an input-aware stacker which is a Gaussian process stacker.

For example the method comprises fitting a distribution to the base outputs and inputting statistics of the distribution to the input-aware stacker.

For example the method comprises reducing the dimensionality of the sensor data features.

For example the method comprises adding first noise to a complete set of training data to create base predictor training data, adding second noise to the complete set of training data to create sensor features and adding third noise to the complete set of training data to create evaluation data, wherein the first, second and third noise is different from each other.

For example the method comprises inputting, to the input-aware stacker, interactions between the statistics and the base outputs.

For example the method comprises computing at least some, but not all, combinations of the features non-linearly.

For example the method comprises reducing the dimensionality of the sensor data features jointly, as part of a process at the input-aware stacker.

For example the method comprises:

accessing training data;

computing a first set of training data from the accessed training data and training each of the base predictors using the first set of training data;

computing a second set of training data from the accessed training data and from outputs of the base predictors, where the first set of training data and the second set of training data are partially or completely overlapping; and

training the input-aware stacker using the second set of training data; wherein the first set of training data and the second set of training data both use the same accessed training data.

For example the method comprises:

computing the first set of training data by adding first noise to the accessed training data; and

computing the second set of training data by adding second noise to features derived from the first set of training data, and by adding the second noise to features derived from the outputs of the base predictors, where the first and second sets of noise are independent of one another.

In an example there is a control system comprising:

an input configured to receive sensor data sensed from a target system to be controlled by the control system;

an input-aware stacker, the input-aware stacker being a predictor; and

a plurality of base predictors configured to compute base outputs from features of the sensor data;

the input-aware stacker being input-aware in that it is configured to take as input the features as well as the base outputs to compute a prediction; and wherein the input-aware stacker is configured to compute the prediction from uncertainty data about the base outputs and/or from at least some non-linear combinations of the features of the sensor data; and

an output configured to send instructions to the target system on the basis of the computed prediction.

In an example there is a control system comprising:

means for receiving sensor data sensed from a target system to be controlled by the control system (for example, the means can be a wired or wireless communications port of a computing device implementing the control system);

means for computing base outputs from features of the sensor data using a plurality of base predictors (for example, base predictors);

means for inputting (such as a wired or wireless communications port or a communications link with an input-aware stacker) at least some of the features and the base outputs to an input-aware stacker to compute a prediction; the input-aware stacker computing the prediction with uncertainty data from the base predictors and/or with at least some combinations of the features of the sensor data; and

means for sending instructions to the target system to control the target system on the basis of the computed prediction (for example, a wired or wireless communications port, a communications link with the target system).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A control system comprising:
an input configured to receive sensor data sensed from a target system to be controlled by the control system;
an input-aware stacker, the input-aware stacker being a predictor;
a plurality of base predictors configured to compute base outputs from features of the sensor data;
the input-aware stacker being input-aware in that it is configured to take as input the features as well as the base outputs to compute a prediction; and wherein the input-aware stacker is configured to compute the prediction from uncertainty data about the base outputs and/or from at least some combinations of the features of the sensor data; and
an output configured to send instructions to the target system on the basis of the computed prediction.

2. The control system of claim 1 wherein the input-aware stacker is a Gaussian process stacker which is a predictor which represents each of its inputs with a normally distributed random variable.

3. The control system of claim 1 comprising a distribution fitter configured to fit, for at least one of the base predictors, a distribution to the base outputs from the at least one base predictor, and wherein the input-aware stacker is configured to take statistics of the distribution as inputs.

4. The control system of claim 3 wherein the input-aware stacker is configured to take as inputs, interactions between the statistics and the base outputs.

5. The control system of claim 1 comprising a feature combiner configured to compute at least some, but not all, combinations of the features non-linearly.

6. The control system of claim 1 comprising a feature combiner configured to compute the combinations of the features, the feature combiner comprising a reducer configured to reduce the dimensionality of the sensor data features.

7. The control system of claim 6 wherein the reducer is configured to reduce the dimensionality of the sensor data features, jointly as part of a process at the input-aware stacker.

8. The control system of claim 6 wherein the reducer is configured to reduce the dimensionality of the sensor data features and to input the reduced dimensionality sensor data features as input to the input-aware stacker.

9. The control system of claim 6 wherein the reducer is configured to compute two or more dimensionality reductions of the sensor data features and to input the reduced dimensionality sensor data features as input to the input-aware stacker.

10. The control system of claim 1 wherein the feature combiner is configured to treat the sensor data features and the base outputs differently.

11. The control system of claim 1 comprising a training system configured to:
access training data;
compute a first set of training data from the accessed training data and train each of the base predictors using the first set of training data;
compute a second set of training data from the accessed training data and from outputs of the base predictors, where the first set of training data and the second set of training data are partially or completely overlapping; and
train the input-aware stacker using the second set of training data; wherein the first set of training data and the second set of training data use the same accessed training data.

12. The control system of claim 11 where the training system is configured to compute the first set of training data by adding a first set of noise to the accessed training data; and
to compute the second set of training data by adding a second set of noise to features derived from the first set of training data, and by adding the second set of noise to features derived from the outputs of the base predictors, where the first and second sets of noise are independent of one another.

13. A computer-implemented method comprising:
receiving sensor data sensed from a target system to be controlled;
computing base outputs from features of the sensor data using a plurality of base predictors;
inputting at least some of the features and the base outputs to an input-aware stacker to compute a prediction; the input-aware stacker computing the prediction with uncertainty data from the base predictors and/or with at least some combinations of the features of the sensor data; and
sending instructions to the target system to control the target system on the basis of the computed prediction.

14. The method of claim 13 comprising using an input-aware stacker which is a Gaussian process stacker.

15. The method of claim 13 comprising fitting a distribution to the base outputs and inputting statistics of the distribution to the input-aware stacker.

16. The method of claim 13 comprising reducing the dimensionality of the sensor data features.

17. The method of claim 13 comprising:
accessing training data;
computing a first set of training data from the accessed training data and training each of the base predictors using the first set of training data;
computing a second set of training data from the accessed training data and from outputs of the base predictors, where the first set of training data and the second set of training data are partially or completely overlapping; and
training the input-aware stacker using the second set of training data; wherein the first set of training data and the second set of training data both use the same accessed training data.

18. The method of claim 17 comprising
computing the first set of training data by adding a first set of noise to the accessed training data; and
computing the second set of training data by adding a second set of noise to features derived from the first set of training data, and by adding the second set of noise to features derived from the outputs of the base predictors, where the first and second sets of noise are independent of one another.

19. The method of claim 15 comprising inputting, to the input-aware stacker, interactions between the statistics and the base outputs.

20. A control system comprising:
an input configured to receive sensor data sensed from a target system to be controlled by the control system;
an input-aware stacker, the input-aware stacker being a predictor; and
a plurality of base predictors configured to compute base outputs from features of the sensor data;
the input-aware stacker being input-aware in that it is configured to take as input the features as well as the base outputs to compute a prediction; and wherein the input-aware stacker is configured to compute the prediction from uncertainty data about the base outputs and/or from at least some non-linear combinations of the features of the sensor data; and
an output configured to send instructions to the target system on the basis of the computed prediction.
